(19) United States
(12) Patent Application Publication
(10) Pub. No.: US 2011/0261299 A1
(43) Pub. Date: Oct. 27, 2011

(54) THREE-DIMENSIONAL DISPLAY

(75) Inventors: Chia-Hsuan Tai, Taichung City (TW); Chao-Yuan Chen, Hsinchu County (TW); Shen-Liang Chen, Changhua County (TW); Wei-Ching Hsu, Hsinchu City (TW); Norio Sugiura, Hsinchu (TW)

(73) Assignee: AU OPTRONICS CORPORATION, Hsinchu (TW)

(21) Appl. No.: 13/084,579

(22) Filed: Apr. 12, 2011

(30) Foreign Application Priority Data
Apr. 26, 2010 (TW) 99113099

(51) Int. Cl. G02F 1/1335

(52) U.S. Cl. 349/98

(57) ABSTRACT

A three-dimensional display includes a liquid crystal display (LCD) panel, a polarizer, a composite optical film, a phase retarder, and an adhesive layer. The LCD panel has a display surface and a rear surface opposite to the display surface. The polarizer is disposed on the rear surface. The composite optical film is disposed on the display surface. The composite optical film includes a quarter wave plate and at least one optical film located between the LCD panel and the quarter wave plate. The phase retarder has a plurality of phase retardation patterns separated from one another, and phase retardation of each phase retardation pattern is λ/2. The adhesive layer is disposed between the composite optical film and the phase retarder, and the phase retarder adheres to the quarter wave plate through the adhesive layer.

### CROSS-REFERENCE TO RELATED APPLICATION

This application claims the priority benefit of Taiwan application serial no. 99113099, filed on Apr. 26, 2010. The entirety of the above-mentioned patent application is hereby incorporated by reference herein and made a part of this specification.

### BACKGROUND OF THE INVENTION

1. Field of the Invention

The invention relates to a display. More particularly, the invention relates to a three-dimensional (3D) display.

2. Description of Related Art

In recent years, as display technology advances, users have become more and more demanding on display quality (such as image resolution and color saturation). Nevertheless, in process of purchasing a display, whether the display is able to display 3D images or not is also taken into consideration in addition to high image resolution and high color saturation.

In view of the appearance, the technology of 3D display can be roughly categorized into two types. One is the stereoscopic type which requires a viewer to wear specially designed glasses, and the other is the auto-stereoscopic type which allows the viewer to watch directly with naked eyes. The stereoscopic type 3D display technology can be realized by using color filter glasses, polarizing glasses, shutter glasses, and so forth. According to the stereoscopic type 3D display technology, a display shows images with special information to the left and the right eyes of the viewer. The different images are viewed by the left and the right eyes of the viewer through the glasses, and the images are combined to form a 3D image.

Based on the stereoscopic type 3D display technology, the display image can be divided into a left-eye visible region and a right-eye visible region by means of a patterned phase retarder, so as to achieve 3D vision effects. To reduce viewing angle dependence of the 3D display and increase the viewing angle of the viewer, the proper patterned phase retarder is chosen to form circular polarized images. In a method of fabricating a conventional 3D display to form the circular polarized images, a quarter phase retardation film and a patterned half phase retardation film are simultaneously formed on a glass substrate, and the 3D image display is formed by adhering the glass substrate and a liquid crystal panel.

To produce the two-layered phase retardation film, i.e. the quarter phase retardation film and the half phase retardation film, a process of coating the phase retardation film is performed twice, and an exposure process is required as well after an alignment film printing process and a rubbing process are implemented, which necessitates high costs and long manufacturing time. Moreover, a cleansing process (e.g. with use of water) cannot be carried out after the quarter phase retardation film is coated onto the glass substrate and before the half phase retardation film is coated onto the glass substrate. As such, pollution such as particles or impurities on the quarter phase retardation film is not easy to be removed. Namely, after the implementation of the process of coating the quarter phase retardation film and before the implementation of the process of coating the half phase retardation film, cleanliness is not apt to be monitored. Thereby, the phase retarder that is formed may be defective, and the quality of the 3D display may be deteriorated.

### SUMMARY OF THE INVENTION

The invention is directed to a 3D display in which a quarter wave plate is not in contact with phase retardation patterns.

In the present invention, a 3D display including a liquid crystal display (LCD) panel, a polarizer, a composite optical film, a phase retarder, and an adhesive layer is provided. The LCD panel has a display surface and a rear surface opposite to the display surface. The polarizer is disposed on the rear surface. The composite optical film is disposed on the display surface. The composite optical film includes a quarter wave plate and at least one optical film located between the LCD panel and the quarter wave plate. The phase retarder has a plurality of phase retardation patterns separated from one another, and phase retardation of each phase retardation pattern is λ/2. The adhesive layer is disposed between the composite optical film and the phase retarder, and the phase retarder adheres to the quarter wave plate through the adhesive layer.

According to an embodiment of the invention, the polarizer includes a first optical film, a second optical film, and a first compensation film, and the second optical film is located between the first optical film and the first compensation film. The first optical film, for example, is a cellulose triacetate (TAC) film, and the second optical film, for example, is a polyvinyl alcohol (PVA) film.

According to an embodiment of the invention, the at least one optical film of the composite optical film includes a second compensation film and a PVA film. The second compensation film is located between the PVA film and the LCD panel, and the PVA film is located between the second compensation film and the quarter wave plate.

According to an embodiment of the invention, the at least one optical film of the composite optical film is a PVA film that is located between the quarter wave plate and the LCD panel.

According to an embodiment of the invention, the phase retarder includes a cover plate, an optical material layer, and a plurality of dummy patterns. The cover plate has an outer surface and an inner surface opposite to the outer surface. The optical material layer is disposed on the inner surface of the cover plate, and the phase retardation patterns are located on the optical material layer. The dummy patterns are disposed on the optical material layer and located among the phase retardation patterns. Phase retardation of the dummy patterns is 0.

According to an embodiment of the invention, optical axes of the phase retardation patterns are substantially parallel to an optical axis of the quarter wave plate.

According to an embodiment of the invention, optical axes of the phase retardation patterns are substantially perpendicular to an optical axis of the quarter wave plate.

In the present invention, a 3D display including an LCD panel, a polarizer, a composite optical film, and a phase retarder is also provided. The LCD panel has a display surface and a rear surface opposite to the display surface. The polarizer is disposed on the rear surface. The composite optical film is disposed on the display surface. The phase retarder is disposed on the composite optical film. The phase retarder includes a cover plate, a plurality of phase retardation patterns separated from one another, and a quarter wave plate. Phase retardation of each of the phase retardation patterns is λ/2. The phase retardation patterns and the quarter wave plate are disposed on two opposite surfaces of the cover plate.

According to an embodiment of the invention, the polarizer includes a first optical film, a second optical film, and a first compensation film, and the second optical film is located between the first optical film and the first compensation film. The first optical film, for example, is a cellulose triacetate (TAC) film, and the second optical film, for example, is a polyvinyl alcohol (PVA) film.

According to an embodiment of the invention, the composite optical film has at least one optical film that includes a TAC film and a PVA film, and the PVA film is located between the TAC film and the LCD panel.

According to an embodiment of the invention, the opposite surfaces of the cover plate are an outer surface and an inner surface, the quarter wave plate is located on the outer surface, and the phase retardation patterns are located on the inner surface.

According to an embodiment of the invention, the phase retarder further includes an optical material layer and a plurality of dummy patterns. The optical material layer is disposed on the inner surface of the cover plate, and the phase retardation patterns are located on the optical material layer. The dummy patterns are disposed on the optical material layer and located among the phase retardation patterns. Phase retardation of the dummy patterns is 0.

According to an embodiment of the invention, the 3D display further includes an adhesive layer disposed between the composite optical film and the phase retarder, and the composite optical film adheres to the phase retardation patterns through the adhesive layer.

According to an embodiment of the invention, optical axes of the phase retardation patterns are substantially parallel to an optical axis of the quarter wave plate.

According to an embodiment of the invention, optical axes of the phase retardation patterns are substantially perpendicular to an optical axis of the quarter wave plate.

In the present invention, a 3D display including a display panel, a polarizer, a composite optical film, and a phase retarder is also provided. The display panel has a display surface and a rear surface opposite to the display surface. The polarizer is disposed on the rear surface. The composite optical film is disposed on the display surface and includes a quarter wave plate. The phase retarder has a plurality of phase retardation patterns, and phase retardation of each of the phase retardation patterns is λ/2. A light beam that is emitted from the display surface and passes through the quarter wave plate is transformed into a circular polarized light beam, and the circular polarized light beam that passes through the phase retardation patterns is transformed into another circular polarized light beam.

According to an embodiment of the invention, the composite optical film further includes an optical film which is located between the quarter wave plate and the display panel.

Based on the above, the quarter wave plate is arranged in the composite optical film in the 3D display, and the phase retarder having the phase retardation patterns adheres to the quarter wave plate through the adhesive layer as described in the embodiments of the invention. Accordingly, the phase retarder can be formed by performing the process of coating the phase retardation film once and implementing the exposure process, such that the manufacturing time and costs can be reduced, and that the cleanliness can be improved in the manufacturing process.

Additionally, in the 3D display described in the embodiments of the invention, the quarter wave plate and the phase retardation patterns are respectively disposed on the two opposite surfaces of the cover plate, so as to simplify the manufacturing process and prevent the phase retarder from being contaminated by particles or impurities.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic partial view of a 3D display according to an embodiment of the invention.

FIG. 1B is a schematic cross-sectional view of a 3D display according to a first embodiment of the invention.

FIG. 2 is a schematic cross-sectional view of a 3D display according to a second embodiment of the invention.

FIG. 3 is a schematic cross-sectional view of a 3D display according to a third embodiment of the invention.

### DESCRIPTION OF EMBODIMENTS

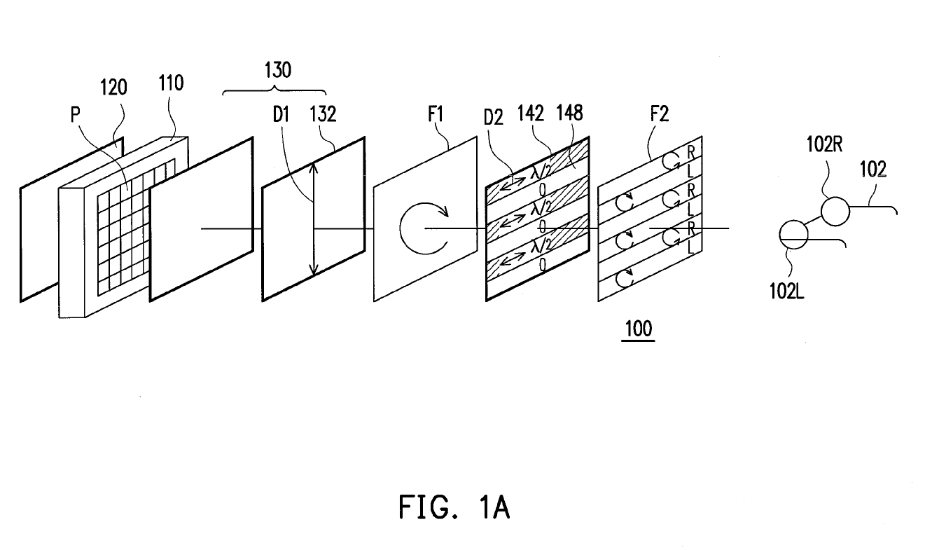

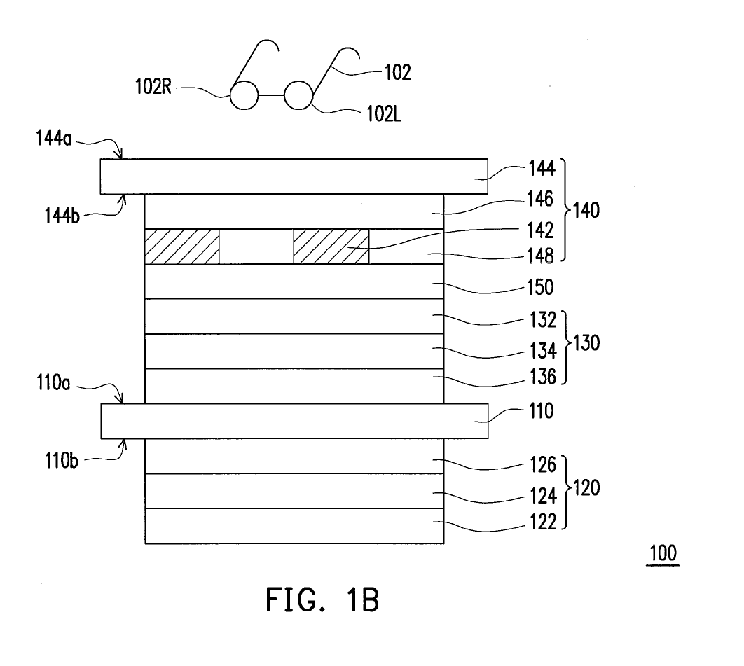

FIG. 1A is a schematic partial view of a 3D display according to an embodiment of the invention. FIG. 1B is a schematic cross-sectional view of a 3D display according to a first embodiment of the invention.

With reference to FIG. 1A and FIG. 1B, a 3D display 100 is adapted for a viewer to watch images through a pair of glasses 102 having two lenses 102L and 102R with different polarization properties. For instance, when the viewer watches images on the 3D display 100 through the pair of glasses 102, the lenses 102L and 102R with different polarization properties allow the left and the right eyes of the viewer to respectively see the left-eye image L and the right-eye image R which have different polarization directions, and thereby the 3D image is provided. The 3D display 100 includes an LCD panel 110, a polarizer 120, a backlight module (not shown), a composite optical film 130, a phase retarder 140, and an adhesive layer 150. In this embodiment, the polarizer 120, the composite optical film 130, the phase retarder 140, and the adhesive layer 150 are all located between the LCD panel 110 and the pair of glasses 102. The polarizer 120 is located between the backlight module and the LCD panel 110.

The LCD panel 110 has a display surface 110a and a rear surface 110b opposite to the display surface 110a. The LCD panel 110 has a plurality of pixels P arranged in an array, and the pixels P are suitable for a user to watch images from the display surface 110a of the LCD panel 110.

The polarizer 120 is disposed on the rear surface 110b of the LCD panel 110. The polarizer 120 includes a first optical film 122, a second optical film 124, and a first compensation film 126. The second optical film 124 is located between the first optical film 122 and the first compensation film 126. The first optical film 122, for example, is a cellulose triacetate (TAC) film, and the second optical film 124, for example, is a polyvinyl alcohol (PVA) film.

The composite optical film 130 is disposed on the display surface 110a of the LCD panel 110. The composite optical film 130 includes a quarter wave plate 132 and at least one optical film located between the LCD panel 110 and the quarter wave plate 132. The quarter wave plate 132, for example, is a polymer film. In an embodiment, the at least one optical film includes a PVA film 134 and a second compensation film 136. The second compensation film 136 is used to polarize light emitted from the LCD panel 110. The second compensation film 136 is located between the PVA film 134 and the LCD panel 110, and the PVA film 134 is located between the second compensation film 136 and the quarter wave plate 132. The quarter wave plate 132, the PVA film 134, and the second compensation film 136 are laminated or adhered together to form the composite optical film 130.

The phase retarder 140 has a plurality of phase retardation patterns 142 separated from one another, and phase retardation of each phase retardation pattern 142 is λ/2. Specifically, the phase retarder 140 can include a cover plate 144, an optical material layer 146, and a plurality of dummy patterns 148. The cover plate 144, for example, is a glass substrate. Besides, the cover plate 144 has an outer surface 144a and an inner surface 144b opposite to the outer surface 144a. The optical material layer 146 is disposed on the inner surface 144b of the cover plate 144, and the optical material layer 146, for example, is polyimide (PI). The phase retardation patterns 142 and the dummy patterns 148 are located on the optical material layer 146. Phase retardation of the dummy patterns 148 is 0. The dummy patterns 148 are located among the phase retardation patterns 142. Namely, the phase retardation patterns 142 having the phase retardation of λ/2 and the dummy patterns 148 having the phase retardation of 0 are alternately arranged, such that two different regions with different phase retardation are formed by the phase retardation patterns 142 and the dummy patterns 148, respectively. In an embodiment, optical axes of the phase retardation patterns 142 have an extension direction D2 that is substantially perpendicular to an extension direction D1 of an optical axis of the quarter wave plate 132.

The arrangement of the different regions with different phase retardation in the phase retarder 140 corresponds to the arrangement of the pixels P on the LCD panel 110, for instance. The phase retarder 140, for example, includes a plurality of stripe-shaped phase retardation patterns 142 and the dummy patterns 148, and each of the stripe-shaped phase retardation patterns 142 and each of the dummy patterns 148 respectively correspond to the pixels P in different rows in the LCD panel 110. Thereby, phase retardation of the image displayed on or light beam emitted from the LCD panel 110 is λ/2 after the image displayed on or light beam emitted from the LCD panel 110 passes through the phase retardation patterns 142, while no phase retardation occurs after the image displayed on or light beam emitted from the LCD panel 110 passes through the dummy patterns 148. Certainly, the phase retardation patterns 142 and the dummy patterns 148 not only can be arranged in a stripe-shaped manner but also can be arranged in island-like patterns, and each island-like pattern respectively corresponds to one or more of the pixels P. In other words, the shape, the dimension, and the arrangement of the phase retardation patterns 142 and those of the dummy patterns 148 are not limited in the present invention. The correlation between the pixels P on the LCD panel 110 and the phase retardation patterns 142 as well as the dummy patterns 148 can be designed by people having ordinary skill in the art based on actual requirements.

In particular, the second compensation film 136 is located between the pixels P and the pair of glasses 102. Therefore, the LCD panel 110 is adapted for displaying a linear polarization image having a polarization direction which is parallel to an extension direction of an optical axis of the second compensation film 136. Here, the optical axis of the second compensation film 136, for example, is perpendicular to an optical axis of the first compensation film 126. After that, due to the phase retardation of λ/4 provided by the quarter wave plate 132, the linear polarization image can be transformed into a circular polarization image which enters the phase retarder 140, as indicated in a frame F1 of FIG. 1A. According to this embodiment, the circular polarization image, for example, is a dextrorotary circular polarization image. The circular polarization image then enters the phase retarder 140 which includes the phase retardation patterns 142 having the phase retardation of λ/2. The phase retardation patterns 142 allow the circular polarization image passing thereby to be transformed into another circular polarization image which has an opposite direction of optical rotation and enters the pair of glasses 102 worn by a user. As shown in FIG. 1A, the dextrorotary circular polarization image is transformed into a levorotary circular polarization image. On the other hand, the dummy patterns 148 have the phase retardation of 0, and therefore optical rotation properties of the circular polarization image remain unchanged after the circular polarization image passes through the dummy patterns 148 of the phase retarder 140 and enters the pair of glasses 102 worn by the user. That is to say, as indicated in FIG. 1A, after the image on the frame F1 passes through the phase retarder 140, a frame F2 is shown. The frame F2 is divided into separate stripe-shaped left-eye image L and right-eye image R which are circular polarization images having different optical rotation properties. Thereby, the left-eye image L and the right-eye image R are overlapped to form the 3D image which is sent to the viewer through the pair of glasses 102, as indicated on the frame F2.

In the exemplary embodiment depicted in FIG. 1A, the optical axes of the phase retardation patterns 142 have the extension direction D2 that is substantially perpendicular to the extension direction D1 of the optical axis of the quarter wave plate 132, which is however not limited in the present invention. According to another embodiment, the optical axes of the phase retardation patterns 142 can be substantially parallel to the optical axis of the quarter wave plate 132.

In FIG. 1B, the adhesive layer 150 is located between the composite optical film 130 and the phase retarder 140, and the phase retarder 140 adheres to the quarter wave plate 132 through the adhesive layer 150. Besides, in another embodiment, the composite optical film 130 and the phase retarder 140 can be bonded to each other by mechanical sealing in replacement of the adhesive layer 150. Adjustment can be made by people having ordinary skill in the art based on actual requirements, and therefore no further description is provided herein.

It should be mentioned that the composite optical film 130 having the quarter wave plate 132 is bonded onto the display surface 110a of the LCD panel 110 according to the embodiments of the invention. The phase retardation patterns 142 are formed in different regions on the optical material layer 146, so as to form the phase retarder 140. The phase retarder 140 then adheres to the composite optical film 130 through the adhesive layer 150. Thus, it is not required to additionally form the quarter phase retardation film before the phase retardation patterns 142 are formed, such that the process of coating the phase retardation film is merely performed once, and that the processing time and costs can be further reduced. On the other hand, the phase retardation patterns 142 are directly formed on the optical material layer 146 according to the embodiments of the invention, such that cleanliness can be effectively improved in the manufacturing process, and that defects can be prevented to a better extent.

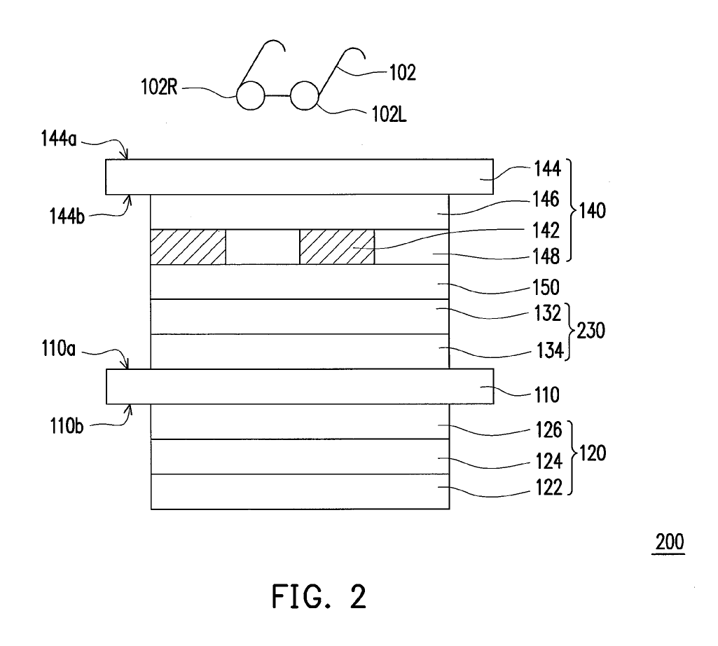

FIG. 2 is a schematic cross-sectional view of a 3D display according to a second embodiment of the invention. Note that in FIG. 2 and FIG. 1B, identical elements are represented by the same reference numbers. Therefore, detailed descriptions thereof are not repeated hereinafter.

According to the second embodiment, the main components of the 3D display 200 depicted in FIG. 2 are similar to those of the 3D display 100 depicted in FIG. 1B except for the optical films of the composite optical film. In the 3D display 100 depicted in FIG. 1B, the composite optical film 130 includes the quarter wave plate 132, the PVA film 134, and the second compensation film 136. By contrast, in the 3D display 200 depicted in FIG. 2, the composite optical film 230 includes the quarter wave plate 132 and the PVA film 134, and the second compensation film is excluded. The PVA film 134 is located between the quarter wave plate 132 and the LCD panel 110.

In this embodiment, the two compensation films on the display surface 110a and the rear surface 110b of the LCD panel 110 are integrated to form a single compensation film on the rear surface 110b of the LCD panel 110, i.e. the first compensation film 126 in the polarizer 120, such that the 3D image can achieve favorable optical effects, and that the 3D image sent to the viewer can have satisfactory resolution.

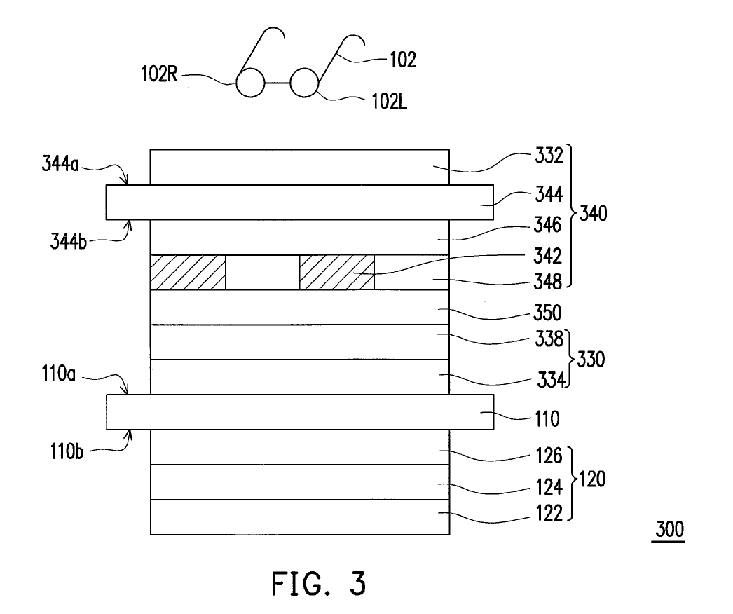

FIG. 3 is a schematic cross-sectional view of a 3D display according to a third embodiment of the invention. Likewise, in FIG. 3 and FIG. 1B, identical elements are represented by the same reference numbers. Therefore, detailed descriptions thereof are not repeated hereinafter.

With reference to FIG. 3, a 3D display 300 includes the LCD panel 110, the polarizer 120, a composite optical film 330, and a phase retarder 340. The LCD panel 110 has a display surface 110a and a rear surface 110b opposite to the display surface 110a. The polarizer 120 is disposed on the rear surface 110b of the LCD panel 110. The composite optical film 330 is disposed on the display surface 110a of the LCD panel 110. The phase retarder 340 is disposed on the composite optical film 330.

The composite optical film 330 has at least one optical film that includes a TAC film 338 and a PVA film 334, and the PVA film 334 is located between the TAC film 338 and the LCD panel 110.

The phase retarder 340 includes a cover plate 344, a plurality of phase retardation patterns 342 separated from one another, and a quarter wave plate 332. Each of the phase retardation patterns 342 has phase retardation of λ/2. The phase retardation patterns 342 and the quarter wave plate 332 are disposed on two opposite surfaces of the cover plate 344. To be more specific, the cover plate 344 has an outer surface 344a and an inner surface 344b opposite to the outer surface 344a. The phase retardation patterns 342 are located on the inner surface 342a, and the quarter wave plate 332 is disposed on the outer surface 344a. The quarter wave plate 332, for example, is a polymer film which can directly adhere to the outer surface 344a of the cover plate 344. In an embodiment, optical axes of the phase retardation patterns 342 can be substantially parallel to or perpendicular to an optical axis of the quarter wave plate 332.

The phase retarder 340 can further include an optical material layer 346 and a plurality of dummy patterns 348. The optical material layer 346 is located on the inner surface 344b of the cover plate 344, and the phase retardation patterns 342 are located on the optical material layer 346. The dummy patterns 348 are disposed on the optical material layer 346 and located among the phase retardation patterns 342. The dummy patterns 348 have phase retardation of 0. Since the phase retardation patterns 342 and the dummy patterns 348 are alternately arranged on the optical material layer 346, the phase retarder 340 has two different regions with different phase retardation, one of which substantially has the phase retardation of λ/2 (the phase retardation patterns 342), the other one of which substantially has the phase retardation of 0 (the dummy patterns 348).

Moreover, according to an embodiment, the 3D display 300 further includes an adhesive layer 350. The adhesive layer 350 is disposed between the composite optical film 330 and the phase retarder 340, and the TAC film 338 of the composite optical film 330 adheres to the phase retardation patterns 342 through the adhesive layer 350.

In this embodiment, the phase retardation patterns 342 and the quarter wave plate 332 are respectively disposed on the inner surface 344b and the outer surface 344a of the cover plate 344, and therefore it is not required to additionally form the quarter phase retardation film before the phase retardation patterns 342 are formed. As such, processing time and costs can be economized, and cleanliness can be improved in the manufacturing process.

To sum up, the 3D display described in the above embodiments of the invention has at least the following features.

The quarter wave plate is excluded from the phase retarder. Therefore, the process of coating the phase retardation film is merely performed once along with the implementation of the exposure process, thus simplifying the entire manufacturing process.

It is not required to additionally form the quarter phase retardation film before the phase retardation patterns are formed, such that residues of particles or impurities are not left in the phase retarder. As a result, cleanliness can be improved, and defects can be prevented.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A three-dimensional display comprising:
a liquid crystal display panel having a display surface and a rear surface opposite to the display surface;
a polarizer disposed on the rear surface;
a composite optical film disposed on the display surface, the composite optical film comprising a quarter wave plate and at least one optical film located between the liquid crystal display panel and the quarter wave plate;
a phase retarder having a plurality of phase retardation patterns separated from one another, phase retardation of each of the phase retardation patterns being λ/2; and
an adhesive layer disposed between the composite optical film and the phase retarder, the phase retarder adhering to the quarter wave plate through the adhesive layer.

2. The three-dimensional display as claimed in claim 1, wherein the polarizer comprises a first optical film, a second optical film, and a first compensation film, and the second optical film is located between the first optical film and the first compensation film.

3. The three-dimensional display as claimed in claim 2, wherein the first optical film is a cellulose triacetate (TAC) film, and the second optical film is a polyvinyl alcohol (PVA) film.

4. The three-dimensional display as claimed in claim 1, wherein the at least one optical film of the composite optical film comprises:
a second compensation film; and
a polyvinyl alcohol (PVA) film, wherein the second compensation film is located between the polyvinyl alcohol film and the liquid crystal display panel, and the polyvinyl alcohol film is located between the second compensation film and the quarter wave plate.

5. The three-dimensional display as claimed in claim 1, wherein the at least one optical film of the composite optical film is a polyvinyl alcohol film, and the polyvinyl alcohol film is located between the quarter wave plate and the liquid crystal display panel.

6. The three-dimensional display as claimed in claim 1, wherein the phase retarder comprises:
a cover plate having an outer surface and an inner surface opposite to the outer surface; and
an optical material layer disposed on the inner surface of the cover plate, the phase retardation patterns being located on the optical material layer; and
a plurality of dummy patterns disposed on the optical material layer and located among the phase retardation patterns, wherein phase retardation of the dummy patterns is 0.

7. The three-dimensional display as claimed in claim 1, wherein optical axes of the phase retardation patterns are substantially parallel to an optical axis of the quarter wave plate.

8. The three-dimensional display as claimed in claim 1, wherein optical axes of the phase retardation patterns are substantially perpendicular to an optical axis of the quarter wave plate.

9. A three-dimensional display comprising:
a liquid crystal display panel having a display surface and a rear surface opposite to the display surface;
a polarizer disposed on the rear surface;
a composite optical film disposed on the display surface;
a phase retarder disposed on the composite optical film, the phase retarder comprising:
a cover plate;
a plurality of phase retardation patterns separated from one another, phase retardation of each of the phase retardation patterns being λ/2; and
a quarter wave plate, the phase retardation patterns and the quarter wave plate being disposed on two opposite surfaces of the cover plate.

10. The three-dimensional display as claimed in claim 9, wherein the polarizer comprises a first optical film, a second optical film, and a first compensation film, and the second optical film is located between the first optical film and the first compensation film.

11. The three-dimensional display as claimed in claim 10, wherein the first optical film is a cellulose triacetate film, and the second optical film is a polyvinyl alcohol film.

12. The three-dimensional display as claimed in claim 9, wherein the composite optical film having at least one optical film, and the at least one optical film comprises:
a cellulose triacetate film; and
a polyvinyl alcohol film located between the cellulose triacetate film and the liquid crystal display panel.

13. The three-dimensional display as claimed in claim 9, wherein the opposite surfaces of the cover plate are an outer surface and an inner surface, the quarter wave plate is located on the outer surface, and the phase retardation patterns are located on the inner surface.

14. The three-dimensional display as claimed in claim 13, wherein the phase retarder further comprises:
an optical material layer disposed on the inner surface of the cover plate, the phase retardation patterns being located on the optical material layer; and
a plurality of dummy patterns disposed on the optical material layer and located among the phase retardation patterns, wherein phase retardation of the dummy patterns is 0.

15. The three-dimensional display as claimed in claim 9, further comprising an adhesive layer disposed between the composite optical film and the phase retarder, the composite optical film adhering to the phase retardation patterns through the adhesive layer.

16. The three-dimensional display as claimed in claim 9, wherein optical axes of the phase retardation patterns are substantially parallel to an optical axis of the quarter wave plate.

17. The three-dimensional display as claimed in claim 9, wherein optical axes of the phase retardation patterns are substantially perpendicular to an optical axis of the quarter wave plate.

18. A three-dimensional display comprising:
a display panel having a display surface and a rear surface opposite to the display surface;
a polarizer disposed on the rear surface;
a composite optical film disposed on the display surface and comprising a quarter wave plate; and
a phase retarder having a plurality of phase retardation patterns separated from one another, phase retardation of each of the phase retardation patterns being λ/2, wherein a light beam emitted from the display surface and passing through the quarter wave plate is transformed into a circular polarized light beam, and the circular polarized light beam passes through the phase retardation patterns and is transformed into another circular polarized light beam.

19. The three-dimensional display as claimed in claim 18, wherein the composite optical film further comprising an optical film located between the quarter wave plate and the display panel.
